(19) United States
(12) Patent Application Publication
(10) Pub. No.: US 2024/0392958 A1
(43) Pub. Date: Nov. 28, 2024

(54) ITEM HAVING A SYSTEM FOR ASSEMBLING AND INDEXING A FIRST ELEMENT WITH A SECOND ELEMENT

(71) Applicant: COMPAGNIE DES CRISTALLERIES DE SAINT LOUIS, SAINT LOUIS LES BITCHE (FR)

(72) Inventors: Jean-François LAVAUD, SCHILTIGHEIM (FR); Antoine TOURSEL, BITCHE (FR); Xuelin TANG, SHENZHEN (CN)

(21) Appl. No.: 18/671,293

(22) Filed: May 22, 2024

(30) Foreign Application Priority Data
May 25, 2023 (FR) 2305198

(51) Int. Cl. F21V 21/40; B25B 27/14; F21V 17/12; F21V 23/04

(52) U.S. Cl. CPC F21V 21/40; B25B 27/14; F21V 17/12; F21V 23/04

(57) ABSTRACT

The invention relates to an item comprising a system for assembling by screwing and indexing a first element having a first cavity (29) with a second element having a second cavity (44), the system being provided with a first mechanism having a movable blocking member (30) housed in the first cavity and configured so that, in a first configuration, the blocking member is in a first position at a distance from the second cavity and rotation of the first element relative to the second element is allowed and, in a second configuration in which the first element and the second element have been screwed together, the blocking member is in a second position introduced both into the second cavity and the first cavity so as to rotatably immobilise the first element relative to the second element.

### TECHNICAL FIELD OF THE INVENTION

The present invention relates to items having a system for assembling and indexing a first element with a second element.

In particular, it may be any item provided with a body and at least one gripping member, such as a handle, to be assembled to the body.

For example, it may be a portable or mobile lighting device, or an item of leatherwork.

### STATE OF THE ART

Many items are known, having a system for assembling and indexing a first element with a second element, including in particular items provided with a body and at least one gripping member, such as handle, to be assembled to the body.

There are many mechanisms for mechanically fastening a handle to the body of such an item.

For example, there are known portable or mobile lighting devices or lamps, the handle of which is screwed to the body of the lamp through the cooperation of a threaded rod protruding from the handle into a tapped port provided in the lamp body.

Assembly is therefore performed by screwing whereas indexing, that is, positioning the handle opposite the lamp body, is carried out when the threaded rod is fully introduced into the tapped port of the lamp body, the handle then being in a so-called end-of-screwing position.

### DISCLOSURE OF THE INVENTION

The invention is intended to provide an item having a system for assembling and indexing a first element with a second element, which is particularly reliable and accurate, while remaining simple and convenient.

Thus, one object of the invention is, in a first aspect, an item including a first element, a second element assembled by screwing to the first element and a system for assembling and indexing the first element with the second element, the first element having a first cavity, the second element having at least one second cavity, and the assembly and indexing system being provided with a first mechanism fitted with a movable blocking member housed at least partially in the first cavity provided in the first element and configured so that, in a first configuration of the item, the blocking member is in a first position in which it is at a distance from the at least one second cavity provided in the second element and rotation of the first element relative to the second element is allowed and, in a second configuration of the item in which the first element and the second element have been screwed together, the blocking member is in a second position in which it is at least partially introduced both into the at least one second cavity of the second element and into the first cavity of the first element so as to rotatably immobilise the first element relative to the second element.

In the first configuration of the item according to the invention, the first mechanism of the assembly and indexing system allows the rotational movement of the first element relative to the second element in order to screw them together and thus enables progressive positioning of the first element and the second element relative to each other, to a determined angular position corresponding to the second configuration of the item according to the invention.

In this second configuration of the item according to the invention, the first mechanism of the assembly and indexing system prohibits the rotational movement of the first element relative to the second element by moving the blocking member from only the first cavity towards both the first cavity and the second cavity.

In other words, the first mechanism of the assembly and indexing system of the item according to the invention makes it possible to form a stop for assembling the first element and the second element with each other, while ensuring reliable assembly and accurate indexing.

Thus, the first mechanism of the assembly and indexing system of the item according to the invention makes it possible to limit screwing of the first element with the second element.

Particularly simple, convenient and economical preferred characteristics of the item according to the invention are set forth below.

The blocking member is magnetic.

The first element has a rod fitted with a threaded endpiece at one end and the assembly and indexing system has a mounting bracket which is mechanically fastened into the second element and against which the first element is immobilised by screwing the threaded endpiece.

The mounting bracket has a plurality of second cavities provided to receive at least partially the blocking member so as to allow a plurality of positions for indexing the first element relative to the second element.

The mounting bracket has a generally cylindrical shape defining a first housing, the assembly and indexing system has a first mounting ring housed in the first housing and provided with an inner threading configured to receive the threaded endpiece of the first element.

The first mounting ring is provided with a notched lower face and the assembly and indexing system furthermore has a second mounting ring which is disposed facing the first mounting ring and which is provided with a notched upper face which is complementary to the notched lower face of the first mounting ring.

The mounting bracket is provided with at least one groove provided in the first housing thereof and the second mounting ring is provided with at least one positioning lug disposed in the at least one groove.

This enables the second mounting ring and therefore also the first mounting ring, to be rotatably immobilised in the mounting bracket when the notched upper face and the notched lower face cooperate.

The assembly and indexing system is furthermore provided with at least one elastic member configured to bias the second mounting ring to move it closer to the first mounting ring.

The at least one elastic member is formed by one or more spring washers.

The assembly and indexing system is furthermore provided with a cover mechanically fastened to the mounting bracket, the at least one elastic member being interposed between the cover and the second mounting ring.

The first element is formed by a gripping handle and the second element is formed by a body to which the gripping handle is mechanically fastened.

The item is a portable or mobile lighting device.

The item includes a light source and a module for supplying the light source, which are disposed in the body, as well as a control module formed by a control button disposed on the gripping handle and by a control rod passing through the gripping handle and disposed protruding in the body to the supply module for activating and/or deactivating the light source.

Alternatively, the item is an item of leatherwork.

One object of the invention is also, in a second aspect, a method for assembling and/or disassembling by screwing and indexing a first element with a second element of an item such as described above, including the steps of:
positioning a blocking member in a first cavity of the first element and holding the blocking member using a tool positioned opposite to the first cavity;
assembling the first element and the second element by screwing by holding the tool in position, the item being in a first configuration, to an indexing position where the blocking member faces a second cavity of the second element;
withdrawing the tool so as to position the blocking member both in the first cavity and in the second cavity and thus rotatably immobilise the first element and the second element relative to each other, the item then being in a second configuration.

The method includes the steps of repositioning the tool opposite to the first cavity to extract the blocking member from the second cavity of the second element; and disassembling the first element and the second element by unscrewing.

### BRIEF DESCRIPTION OF THE FIGURES

The invention, according to one example embodiment, will be better understood and the advantages thereof will become clearer upon reading the following detailed description, which is given by way of indicating and in no way limiting purposes, with reference to the appended drawings.

FIG. 1 is a front view of a portable lighting device provided with a gripping handle, a lamp body and an assembly and indexing system configured to screw the handle to the lamp body.

FIG. 2 is a cross-section view represented II-II in FIG. 1.

FIG. 3 is a front face of the gripping handle and the assembly and indexing system taken in isolation.

FIG. 4 is an exploded perspective view of the gripping handle and the assembly and indexing system visible in FIG. 3.

FIG. 5 is an isolated perspective view of the gripping handle.

FIG. 6 is a perspective view showing a mounting plate of the assembly and indexing system.

FIG. 7 is a view similar to FIG. 6, taken from a different viewing angle.

FIG. 8 is a perspective view showing a first mounting ring of the assembly and indexing system in isolation.

FIG. 9 is a bottom view of the first mounting ring of FIG. 8.

FIG. 10 is a perspective view showing a second mounting ring of the assembly and indexing system in isolation.

FIG. 11 is a top view of the second mounting ring of FIG. 10.

FIG. 12 is a perspective view showing a cover of the assembly and indexing system in isolation.

FIG. 13 is a view similar to FIG. 14, taken from a different viewing angle.

FIG. 14 is a cross-section view represented XIV-XIV in FIG. 3, showing the set formed by the gripping handle and the assembly and indexing system in an assembled so-called second configuration of the item.

FIG. 15 is a view similar to FIG. 14, showing the set formed by the gripping handle and the assembly and indexing system in a disassembled so-called first configuration of the item.

### DETAILED DESCRIPTION OF THE INVENTION

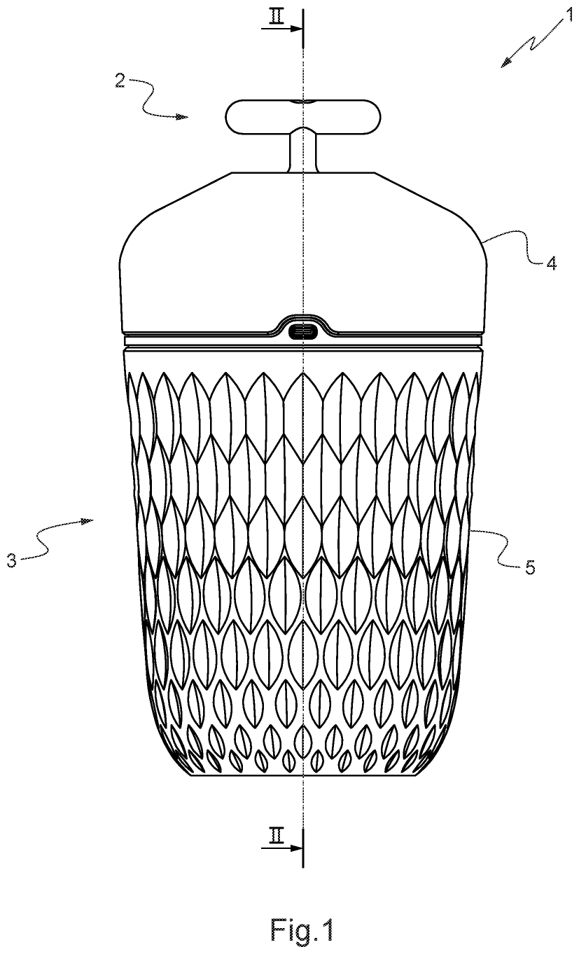

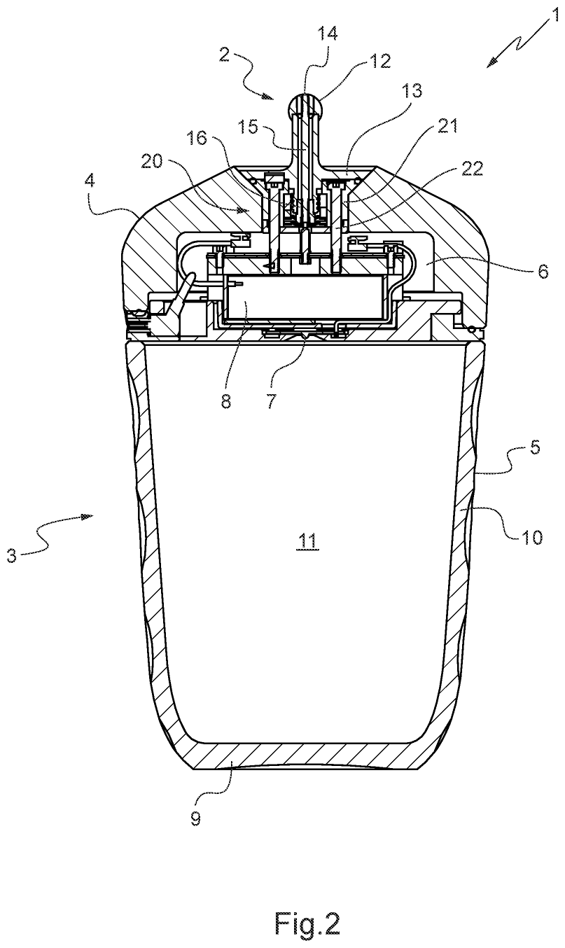

FIGS. 1 and 2 illustrate an item, in particular here a portable or mobile lighting device 1.

This device 1 is fitted with a first element formed here by a gripping handle 2 and with a second element formed here by a body 3.

The gripping handle 2 is mechanically fastened, by screwing, to the body 3.

In the example illustrated, the body 3 includes an upper part 4 to which the gripping handle 2 is mounted and a lower part 5 mechanically fastened with the upper part 4, for example by screwing, snap-fitting or any other mechanical fastening means.

As visible in FIG. 2, the upper part 4 has a reception housing 6 and the device 1 includes a light source 7 and a module 8 for supplying the light source 7 which are disposed in the reception housing 6.

The light source 7 is arranged so as to be directed to the lower part 5 which here forms a member for scattering the light emitted by the light source 7 when it is activated by the supply module 8.

The lower part 5 here has a flat bottom 9 and a cylindrical side wall 10 which extends from the flat bottom 9 and which defines an inner scattering space 11. The device 1 can thus be put with its flat bottom 9 on any bracket.

In the example illustrated, the lower part 5 is for example made of crystal whereas the upper part 4 is made of wood or composite. Other materials can be used.

The handle 2 here is formed by a gripping and actuating member 12, and by a mounting plate 13 connected to the gripping member 12 and configured to be at least partially mounted into the reception housing 6 of the upper part 4, opposite to the light source 7.

The device 1 furthermore includes a control module formed by a control button 14 arranged on the gripping and actuating member 12 of the gripping handle 2, by a control rod 15 passing through the mounting plate 13 of the gripping handle 2 and by a guide endpiece 16 fixed to one end of the control rod 15, opposite to the control button 14.

The control rod 15 is disposed protruding into the reception housing 6 of the upper part 4 and has a free end which comes into contact with the supply module 8 for activating and/or deactivating the light source 7 of the device 1.

In the device 1 according to the invention, the gripping handle 2 is mechanically fastened to the body 3 in a so-called indexing position.

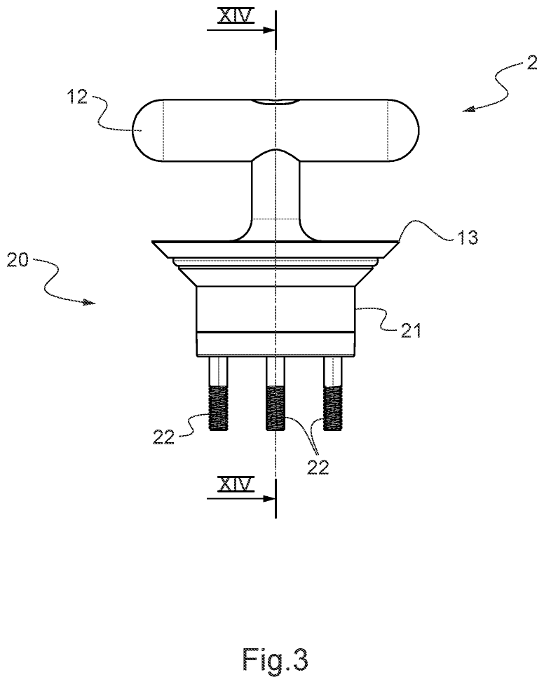

In particular, as visible in FIGS. 2 and 3, the device includes an assembly and indexing system 20 provided with a mounting bracket 21 on which the mounting plate 13 is disposed.

The mounting bracket 21 is in turn configured to be mechanically fastened, here using first screws 22, to the supply module 8 in the reception housing 6 of the upper part 4.

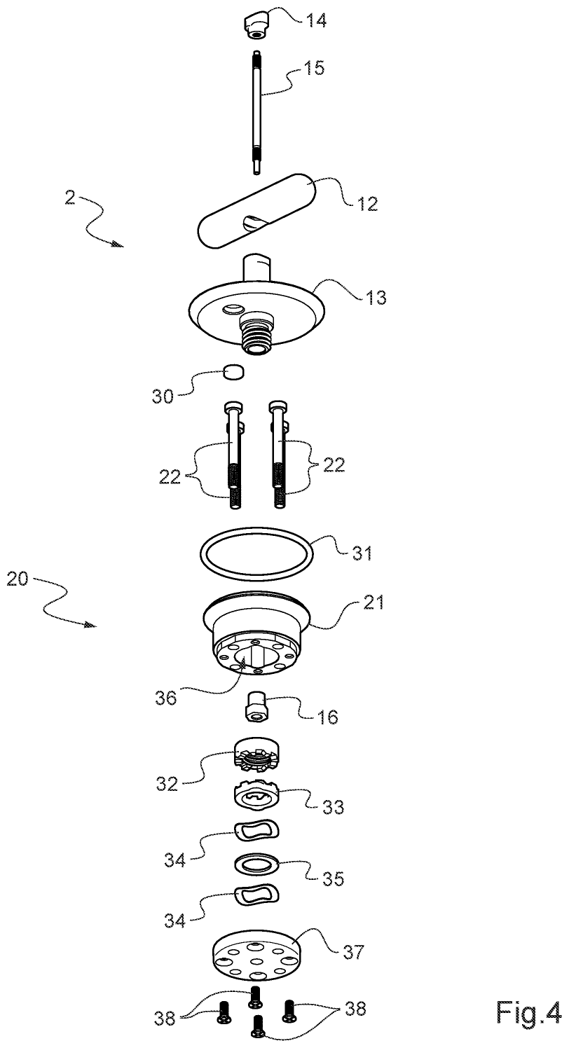

With reference to FIGS. 4 to 13, the set formed by the gripping handle 2 and the assembly and indexing system 20 will be described in more detail.

As visible in FIG. 4, the set above is in particular formed by the gripping handle 2, including the gripping and actuating member 12 thereof and the mounting plate 13 thereof, by the control module formed by the control button 14, the control rod 15 and the guide endpiece 16, and by the assembly and indexing system 20, including the mounting bracket 21 thereof and the first screws 22.

Furthermore, the assembly and indexing system 20 is provided with a first mechanism fitted with a movable blocking member which is here magnetic and in particular formed by a magnet 30, which magnet 30 is located between the mounting plate 13 and the mounting bracket 21.

The assembly and indexing system 20 is also provided with a sealing member 31, here an O ring, which is disposed between the mounting plate 13 and the mounting bracket 21.

In the example illustrated, the assembly and indexing system 20 is furthermore provided with a first mounting ring 32, a second mounting ring 33 and a plurality of elastic members which are here formed by curved 34 and flat 35 spring washers, all these elements forming a second mechanism.

The mounting bracket 21 has a generally cylindrical shape defining a first housing 36 provided to receive the first mounting ring 32, the second mounting ring 33 and the curved 34 and flat 35 spring washers.

In the example illustrated, the assembly and indexing system 20 is also provided with a cover 37 mechanically fastened to the mounting bracket 21, opposite to the mounting plate 13, using second screws 38.

The assembly and indexing system 20 is here configured so that the curved 34 and flat 35 spring washers bear against the cover 37.

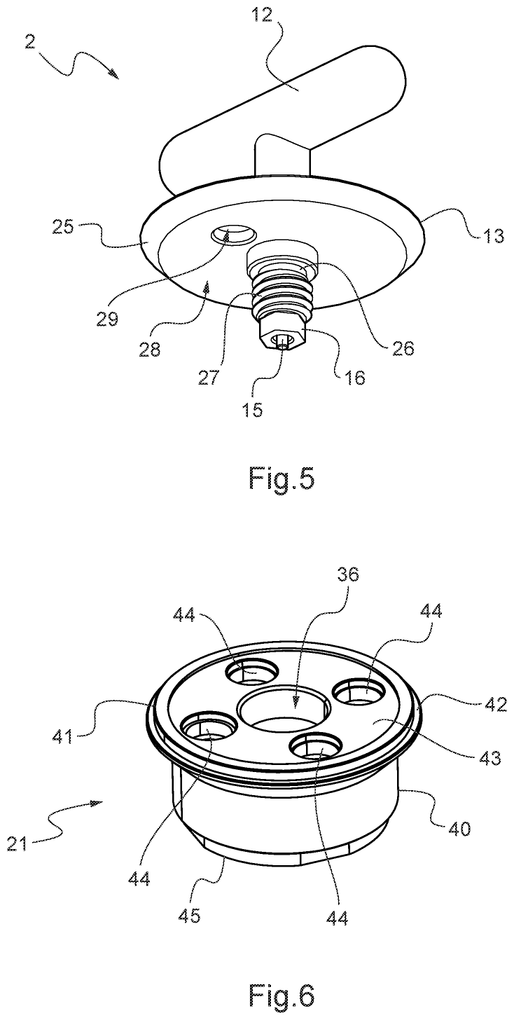

With reference to FIG. 5, the mounting plate 13 includes a main wall 25 and a rod 26 extending protruding from the main wall 25 and fitted with a threaded endpiece 27 at one end.

The mounting plate 13 has a lower face 28 in which a first cavity 29 is provided.

The first cavity 29 is provided to receive at least partially the magnet 30.

The control button 14 is configured to be connected to the control rod 15, on the side of the gripping and actuating member 12.

The guide endpiece 16 is configured to be connected to the control rod 15, opposite to the side of the threaded endpiece 27.

The control rod 15 thus passes through the gripping and actuating member 12 and the mounting plate 13 until it protrudes beyond the threaded endpiece 27.

A free end of the contact rod 15 also protrudes from the guide endpiece 16.

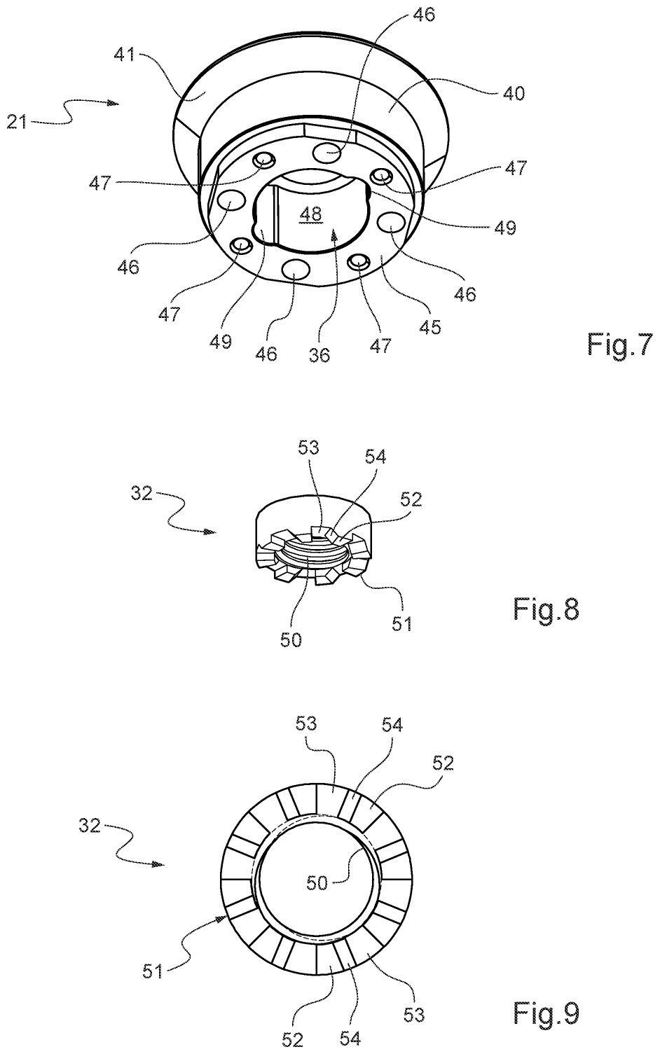

With reference to FIGS. 6 and 7, the generally cylindrical mounting bracket 21 has a main body 40 having formed thereon an upper wall 41 provided with a sealing edge 42 and an upper face 43.

The sealing edge 42 is provided to receive the sealing member 31.

The mounting bracket 21 here has a plurality of second cavities 44 provided in the upper face 43.

The first housing 36 passes through the main body 40 and opens into the upper face 43.

Here, the main body 40 furthermore has a lower wall 45, through ports 46 which open into the lower wall 45 and opposite, into the second cavities 44, and tapped blind holes 47 which open into the lower wall 45.

The through ports 46 are provided to receive the first screws 22, the screw heads being received at the bottom of the second cavities 44, whereas the blind holes 47 are provided to receive the second screws 38.

The main body 40 has an inner wall 49 bounding the first housing 36 and grooves 48 provided in the inner wall 49 and which open into the lower wall 45.

With reference to FIGS. 8 and 9, the first mounting ring 32, which is provided to be housed in the first housing 36 of the mounting bracket 21, has a generally annular shape and is provided with an inner threading 50 and a notched lower face 51.

The assembly and indexing system 20 is here configured so that the threaded endpiece 27 of the mounting plate 13 of the gripping handle 2 cooperates with the inner threading 50 of the first mounting ring 32.

The notched lower face 51 has a plurality of raised portions, called bumps 52, separated from a plurality of recessed portions, called hollows 53.

The successions of successive bumps 52 and hollows 53 are here each separated by a ramp portion 54.

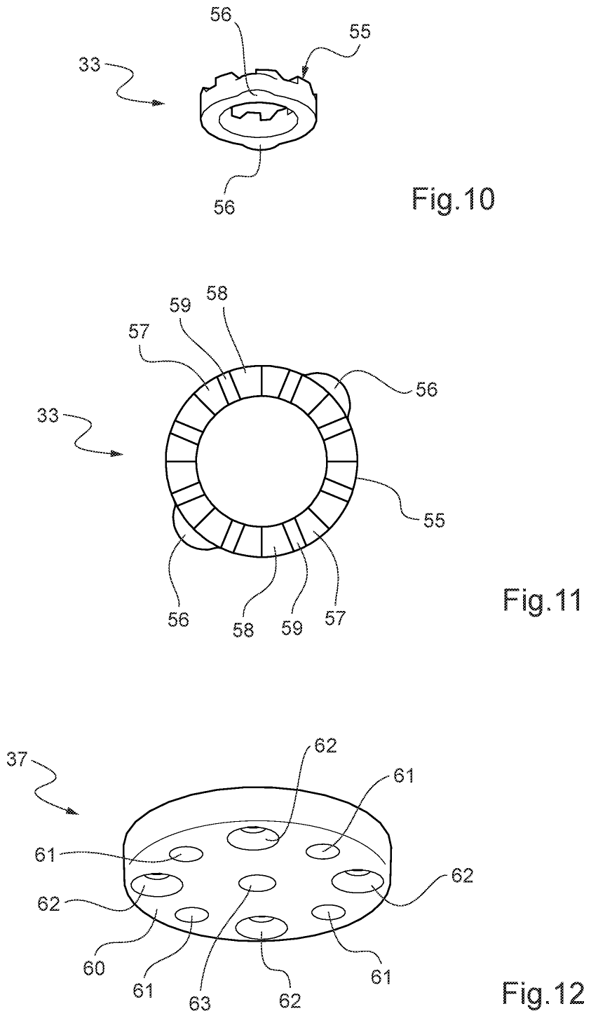

With reference to FIGS. 10 and 11, the second mounting ring 33, which is also provided to be housed in the first housing 36 of the mounting bracket 21, facing the first mounting ring 32, has a generally annular shape and is provided with a notched upper face 55 which is complementary to the notched lower face 51 of the first mounting ring 32, and with positioning lugs 56.

The assembly and indexing system 20 is here configured so that the positioning lugs 56 of the second mounting ring 33 are received in the grooves 49 of the mounting bracket 21 and the notched upper face 55 of the second mounting ring 33 cooperates with the notched lower face 51 of the first mounting ring 32.

The notched upper face 55 has a plurality of complementary raised portions, called complementary bumps 57, separated from a plurality of complementary recessed portions, called complementary hollows 58.

The successions of successive complementary bumps 57 and complementary hollows 58 are here each separated from a complementary ramp portion 59.

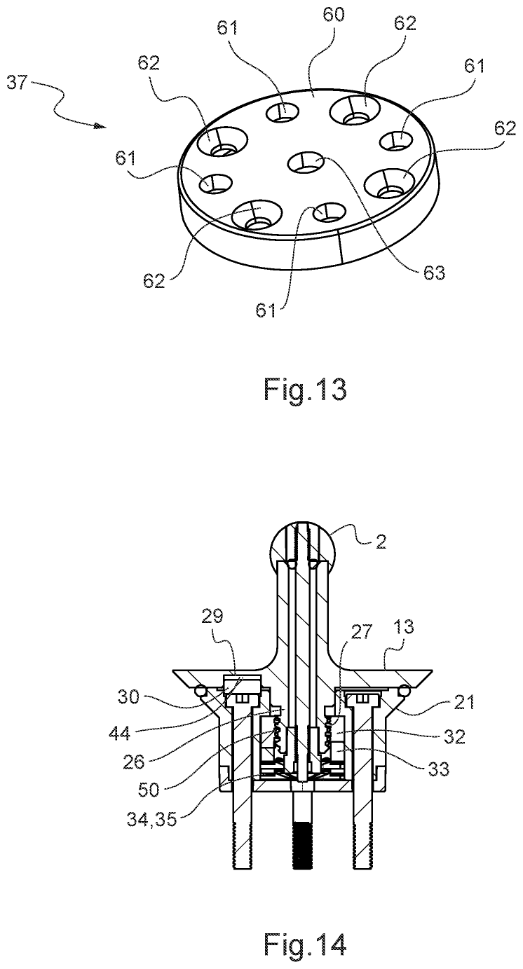

With reference to FIGS. 12 and 13, the cover 37 which is provided to be mechanically fastened to the mounting bracket 21, opposite to the mounting plate 13, has a bottom wall 60 in which a plurality of complementary through ports 61, complementary through holes 62, as well as a central through port 63, are provided.

The complementary through ports 46 are provided to receive the first screws 22, the complementary through holes 62 are provided to receive the second screws 38 with the screw heads being received at the bottom of the complementary through holes 62, and the central through port 63 is provided to receive the free end of the control rod 15 of the control module.

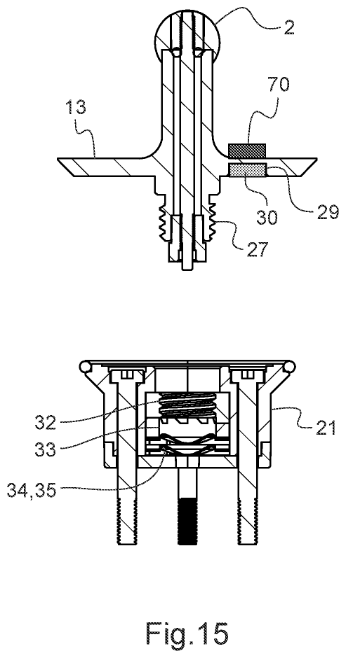

With reference to FIGS. 14 and 15, the assembling and disassembling of the gripping handle 2 with the body 3, using the assembly and indexing system 20 and a tool 70, will now be described in more detail.

In FIG. 14, the gripping handle 2 is assembled with the body in an indexing so-called second position, defined by the presence of the magnet 30 both in the first cavity 29 and in one of the second cavities 44.

The item is thus in an assembled so-called second configuration, in which rotation of the gripping handle 2 relative to the body 3 is prevented.

In other words, this configuration enables the gripping handle 2 to be rotatably immobilised relative to the body.

In particular, the lower face 28 of the mounting plate 13 is immobilised against the upper face 43 of the mounting bracket 21.

Furthermore, in the assembled configuration, the threaded endpiece 27 of the rod 26 of the mounting plate 13 is screwed in the inner threading 50 of the first mounting ring 32, the curved 34 and flat 35 spring washers bias the second ring 33 against the first mounting ring 32 so that the notched upper face 55 of the second mounting ring 33 cooperates with the notched lower face 51 of the first mounting ring 32.

However, the bias exerted by the curved 34 and flat 35 spring washers enables the first mounting ring 32 to rotate relative to the second mounting ring 33 when the threaded endpiece of the rod 26 of the mounting plate 13 is screwed beyond a certain threshold, even when the notched upper face 55 of the second mounting ring 33 cooperates with the notched lower face 51 of the first mounting ring 32.

In other words, the second mechanism is configured so that the first mounting ring 32 is not rotatably locked, thus allowing clamping even beyond a certain threshold, without however deteriorating the item.

Such a bias exerted by the curved 34 and flat 35 spring washers, in combination with the cooperation of the notched upper face 55 of the second mounting ring 33 with the notched lower face 51 of the first mounting ring 32, furthermore makes it possible to compensate for a possible axial clearance resulting from the cooperation between the threaded endpiece 27 of the rod 26 of the mounting plate 13 and the inner threading 50 of the first mounting ring 32.

In FIG. 15, the gripping handle 2 is disassembled from the body.

The item is thus in a disassembled so-called first configuration, in which rotation of the gripping handle 2 relative to the body 3 is allowed.

In other words, this configuration enables rotation and therefore screwing and/or unscrewing of the gripping handle 2 relative to the body.

In particular, the mounting plate 13 is at a distance from the mounting bracket 21 and the magnet 30 is introduced only into the first cavity 29 of the mounting plate, where it is in a first position.

The magnet 30 is held in the first position thereof by means of the tool 70 which is positioned facing the magnet 30 on the opposite side of the mounting plate 13.

For example, it may be a tool having magnetic properties capable of attracting the magnet 30.

Furthermore, in the disassembled configuration, the threaded endpiece 27 of the rod 26 of the mounting plate 13 is unscrewed from the first mounting ring 32, the curved 34 and flat 35 spring washers do not enable the second ring 33 to be biased against the first ring 32 for them to cooperate as in the assembled configuration.

More generally, a method for assembling and then disassembling by screwing and indexing the gripping handle 2 with the body 3 of the item, includes the steps of:
positioning the magnet 30 in the first cavity 29 of the mounting plate 13 and holding it using the tool 70 positioned opposite;
assembling the gripping handle 2 and the body 3 by screwing by holding the tool 70 in position, the item 1 being in the first configuration, to the indexing position where the magnet 30 faces a second cavity 44 of the mounting bracket 21;
withdrawing the tool so as to position the magnet 30 both in the first cavity 29 and in the second cavity 44 and thus rotatably immobilise the gripping handle 2 and the body 3 relative to each other, the item 1 then being in the second configuration;
repositioning the tool 70 opposite to the first cavity 29 to extract the magnet 30 from the second cavity 44;
disassembling the gripping handle 2 from the body 3 by unscrewing.

Non illustrated alternatives are described below.

The gripping handle of the lighting device can be configured to be hung.

The item is not a portable or mobile lighting device, but rather an item of leatherwork, fitted with a handle or strap to be assembled to a body fitted with a storage compartment.

The second element of the item may include more or fewer cavities, and therefore more or fewer positions for indexing the first element to the second element.

The first and second mounting rings can be formed as a single piece mounted rotatably fixed into the mounting bracket.

The first and second mounting rings can be formed as a single piece integral with the mounting bracket.

The assembly and indexing system may be devoid of the second mechanism fitted with rings and elastic members.

More generally, it should be noted that the invention is not limited to the examples described and illustrated.

1. An item including a first element (2), a second element (3) assembled by screwing to the first element and a system for assembling and indexing (20) the first element to the second element, the first element having a first cavity (29), the second element having at least one second cavity (44), and the assembly and indexing system being provided with a first mechanism fitted with a movable blocking member (30) housed at least partially in the first cavity provided in the first element and configured so that, in a first configuration of the item, the blocking member is in a first position in which it is at a distance from the least one second cavity provided in the second element and rotation of the first element relative to the second element is allowed and, in a second configuration of the item in which the first element and the second element have been screwed together, the blocking member is in a second position in which it is at least partially introduced both into the at least one second cavity of the second element and into the first cavity of the first element so as to rotatably immobilise the first element relative to the second element.

2. The item according to claim 1, characterised in that the blocking member (30) is magnetic.

3. The item according to claim 1, characterised in that the first element (2) has a rod (26) fitted with a threaded endpiece (27) at one end and the assembly and indexing system (20) has a mounting bracket (21) which is mechanically fastened in the second element (3) and against which the first element is immobilised by screwing of the threaded endpiece.

4. The item according to claim 3, characterised in that the mounting bracket (21) has a plurality of second cavities (44) provided to at least partially receive the blocking member (30) so as to allow a plurality of positions for indexing the first element (2) relative to the second element (3).

5. The item according to claim 3, characterised in that the mounting bracket (21) has a generally cylindrical shape defining a first housing (36), the assembly and indexing system (20) has a first mounting ring (32) housed in the first housing and provided with an inner thread (50) configured to receive the threaded endpiece (27) of the first element (2).

6. The item according to claim 5, characterised in that the first mounting ring (32) is provided with a notched lower face (51) and the assembly and indexing system (20) furthermore has a second mounting ring (33) which is disposed facing the first mounting ring and which is provided with a notched upper face (55) which is complementary to the notched lower face of the first mounting ring.

7. The item according to claim 6, characterised in that the mounting bracket (21) is provided with at least one groove (49) provided in its first housing (36) and the second mounting ring (33) is provided with at least one positioning lug (56) disposed in the at least one groove.

8. The item according to claim 6, characterised in that the assembly and indexing system (20) is furthermore provided with at least one elastic member (34, 35) configured to bias the second mounting ring (33) to move it closer to the first mounting ring (32).

9. The item according to claim 8, characterised in the at least one elastic member (34, 35) is formed by one or more spring washers.

10. The item according to claim 8, characterised in that the assembly and indexing system (20) is furthermore provided with a cover (37) mechanically fastened to the mounting bracket (21), with the at least one elastic member being interposed between the cover and the second mounting ring (33).

11. The item according to claim 1, characterised in that the first element (2) is formed by a gripping handle and the second element (3) is formed by a body to which the gripping handle is mechanically fastened.

12. The item according to claim 11, characterised in that it is a portable or mobile lighting device.

13. The item according to claim 12, characterised in that it includes a light source (7) and a module (8) for supplying the light source, which are disposed in the body, as well as a control module formed by a control button (14) disposed on the gripping handle and by a control rod (15) passing through the gripping handle and disposed protruding in the body to the supply module for activating and/or deactivating the light source.

14. A method for assembling and/or disassembling by screwing and indexing a first element (2) with a second element (3) of an item (1) according to claim 1, including the steps of:
positioning a blocking member (30) in a first cavity (29) of the first element and holding the blocking member using a tool (70) positioned opposite to the first cavity;
assembling the first element and the second element by screwing by holding the tool in position, the item (1) being in a first configuration, to an indexing position where the blocking member faces a second cavity (44) of the second element;
withdrawing the tool so as to position the blocking member both in the first cavity and in the second cavity and thus rotatably immobilise the first element and the second element relative to each other, the item then being in a second configuration.

15. The method according to claim 14, characterised in that it includes the steps of repositioning the tool (70) opposite to the first cavity (29) to extract the blocking member (30) from the second cavity (44) of the second element (3); and disassembling the first element (2) and the second element by unscrewing.
